(19) United States
(12) Patent Application Publication
(10) Pub. No.: US 2026/0362127 A1
(43) Pub. Date: Nov. 12, 2026

(54) FINE-GRAINED SECURE E2E COMMUNICATIONS

(71) Applicant: InterDigital Patent Holdings, Inc., Wilmington, DE (US)

(72) Inventors: Yi Zhang, San Jose, CA (US); Samir Ferdi, Kirkland (CA); Chonggang Wang, Princeton, NJ (US); Zhibi Wang, Woodridge, IL (US); Robert Gazda, Spring City, PA (US); Alec Brusilovsky, Downingtown, PA (US)

(73) Assignee: InterDigital Patent Holdings, Inc., Wilmington, DE (US)

(21) Appl. No.: 19/202,774

(22) Filed: May 8, 2025

(51) Int. Cl. H04W 12/041; H04L 65/1069; H04W 12/084

(52) U.S. Cl. CPC H04W 12/041; H04L 65/1069; H04W 12/084

(57) ABSTRACT

Fine-grained secure end-to-end connection procedures are disclosed herein. A wireless transmit/receive unit (WTRU) may send, to a first network node, a protocol data unit (PDU) session request message including information for setting up a level of security for a requested service. The WTRU may send, to a second network node, a secure service connection request message including the information for setting up the level of security for the requested service, the WTRU receive, from a third network node, a response message including a fine-grained security profile, the WTRU may receive, from the second network node, an indication of successful key derivation and key lifetime, the WTRU may derive, based on a root key and the fine-grained security profile, a unique key pair, including first and second shared keys, for the WTRU to provide secure end-to-end communication with the second network node for the requested service.

### BACKGROUND

In 3rd Generation Partnership Project (3GPP) fifth generation (5G) systems, non-access stratum (NAS) signaling between a wireless transmit/receive unit (WTRU) and the 5g core (5GC) may terminate at the access and mobility management function (AMF) via an N1 interface. The WTRU may communicate with other 5GC network functions (NFs) (e.g., session management function (SMF)) using NAS transport via AMF by means of dedicated (e.g., session management (SM)) transparent containers, which the AMF may forward using the service based interface (SBI) to invoke Nsmf service. 3GPP has defined location services (LCS) feature over the user plane (UP) between WTRU and the location management function (LMF).

### SUMMARY

Fine-grained secure end-to-end connection procedures are disclosed herein. A wireless transmit/receive unit (WTRU) may send, to a first network node, a protocol data unit (PDU) session request message including information for setting up a level of security for a requested service. The WTRU may send, to a second network node, a secure service connection request message including the information for setting up the level of security for the requested service. the WTRU receive, from a third network node, a response message including a fine-grained security profile, the WTRU may receive, from the second network node, an indication of successful key derivation and key lifetime, the WTRU may derive, based on a root key and the fine-grained security profile, a unique key pair, including first and second shared keys, for the WTRU to provide secure end-to-end communication with the second network node for the requested service.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example non-roaming 3rd Generation Partnership Project (3GPP) fifth generation (5G) system architecture;

FIG. 3 is a system diagram illustrating an example 3GPP 6G system architecture to support secure end-to-end (E2E) WTRU-network function (NF) communications;

FIG. 4 is a hierarchical diagram illustrating an example key hierarchy;

FIG. 5 is a hierarchical diagram illustrating another example key hierarchy;

FIG. 6 is a hierarchical diagram illustrating another example key hierarchy;

FIG. 7 is a hierarchical diagram illustrating another example key hierarchy;

FIG. 8 is a flow diagram illustrating an example WTRU-NF fine-grained secure E2E user plane (UP) communication setup procedure during protocol data unit (PDU) session establishment;

FIG. 9 is a flow diagram illustrating an example WTRU-NF fine-grained secure E2E user plane communication setup procedure via UP;

FIG. 10 is a flow diagram illustrating an example WTRU-NF fine-grained secure E2E communication setup procedure via control plane (CP);

FIG. 11 is a flow diagram illustrating an example application function (AF) requested WTRU-NF fine-grained secure E2E UP communication establishment procedure;

FIG. 12 is a flow diagram illustrating an example WTRU requested post-quantum cryptography (PQC)-based WTRU-NF fine-grained secure E2E communication establishment procedure via security function (SF);

FIG. 13 is a flow diagram illustrating an example fine-grained secure E2E communication procedure with the NF based on PQC protection; and

FIG. 14 is a flow diagram illustrating an example fine-grained secure end-to-end connection establishment procedure between a WTRU and an NF using a key distribution approach.

### DETAILED DESCRIPTION

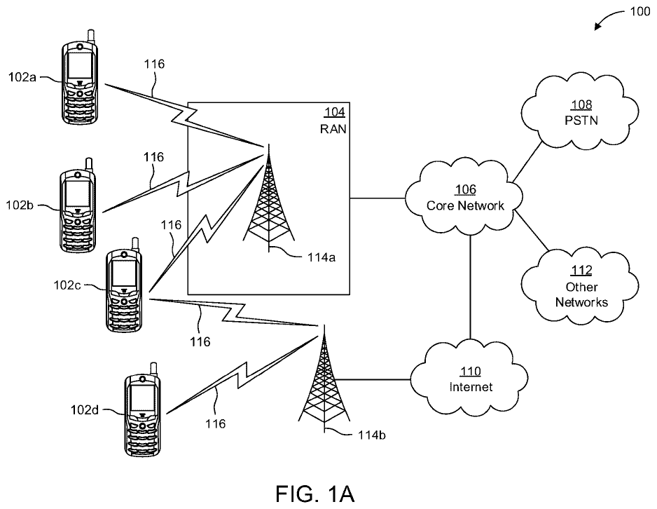

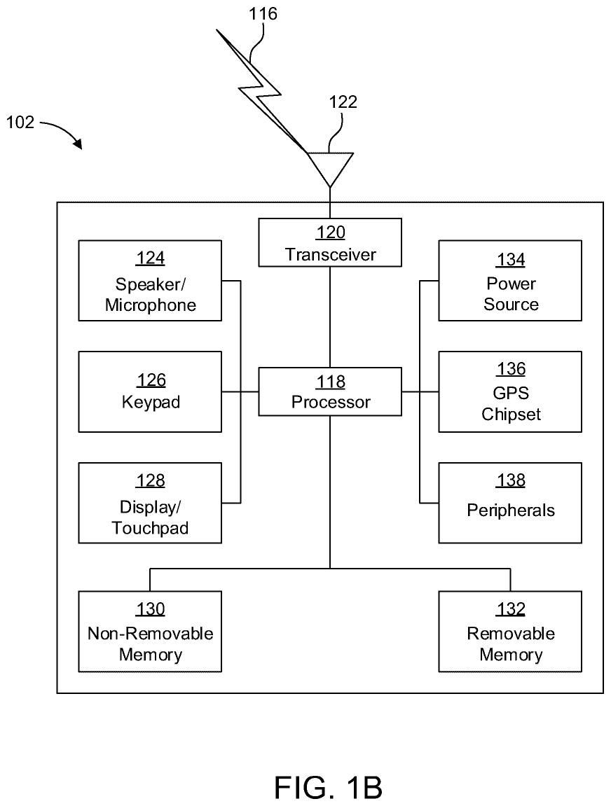

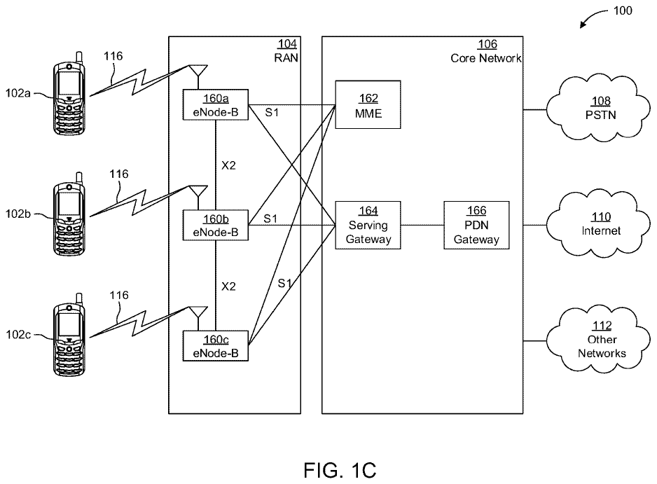

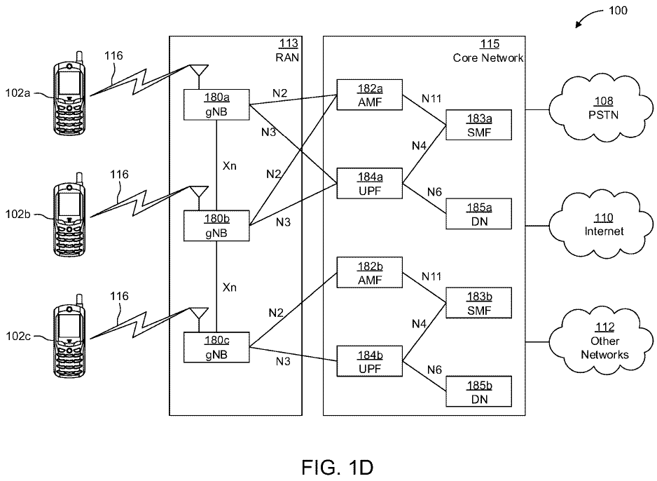

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Any of the following abbreviations and acronyms may be used herein:
3GPP—3rd Generation Partnership Project
5G-AKA—5G Authentication and Key Agreement
AES—Advanced Encryption Standard, a type of symmetric encryption
AKA—Authentication and Key Agreement
AS—Access Stratum
CRYSTALS-Kyber—A post-quantum cryptographic candidate algorithm for public-key encryption
CRYSTALS-Dilithium—A post-quantum cryptographic candidate algorithm for digital signature
DSA—Digital Signature Algorithm
EAP-AKA—Extensible Authentication Protocol for AKA
EAP-TLS—Extensible Authentication Protocol with Transport Layer Security
ECC—Elliptic Curve Cryptography
FALCON—A post-quantum cryptographic candidate algorithm for digital signature
GUTI—Globally Unique Temporary Identifier
HQC—Hamming Quasi-Cyclic, A post-quantum cryptographic candidate algorithm for public-key encryption
IPSec—Internet Protocol Security
KEM—Key Encapsulation Mechanism
MSSK—Master Shared Secret Key
NAS—Non-Access Stratum
NF—Network Function
PCC—Policy and Charging Control
PCF—Policy Control Function
PDU—Protocol Data Unit
PQC—Post-Quantum Cryptography
PSA—UPF PDU Session Anchor UPF
PSK—Pre-Shared Key
QSC—Quantum-Safe Cryptography
RAN—Radio Access Network
RSA—Rivest-Shamir-Adleman, a type of asymmetric encryption
SBA—Service Based Architecture
SBI—Service Based Interface
SDF—Service Data Flow
SEAF—Security Anchor Function
SF—Security Function
SMF—Session Management Function
SBI—Service-Based Interface
SUPI—Subscription Permanent Identifier
TLS—Transport Layer Security
UP—User Plane
UPF—User Plane Function
SPHINCS—A post-quantum cryptographic candidate algorithm for digital signature

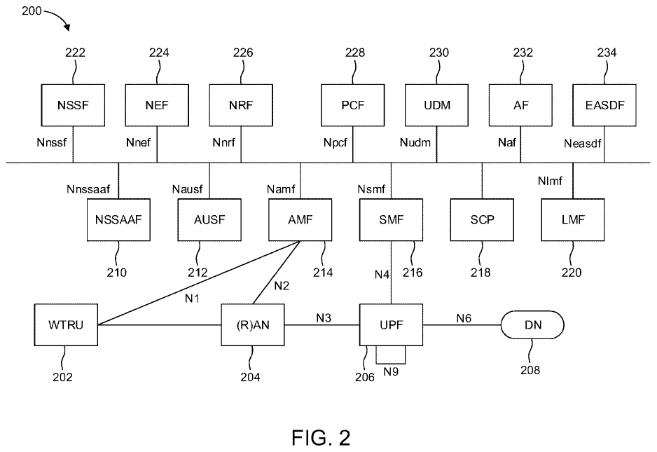

FIG. 2 is a system diagram illustrating an example non-roaming 3rd Generation Partnership Project (3GPP) fifth generation (5G) system architecture 200. The non-roaming 5G system architecture 200 may include: WTRU 202; RAN 204; UPF 206; data network (DN) 208; network slice-specific authentication and authorization function (NSSAAF) 210; authentication server function (AUSF) 212; the access and mobility management function (AMF) 214; session management function (SMF) 216; service communication proxy (SCP) 218; location management function (LMF) 220; network slice selection function (NSSF) 222; network exposure function (NEF) 224; network repository function (NRF) 226; policy control function (PCF) 228; unified data management (UDM) 230; application function (AF) 232; and edge application server discovery function (EASDF) 234. In the non-roaming 5G system architecture 200, non-access stratum (NAS) signaling between a WTRU 202 and the 5g core (5GC) may terminate at the AMF 214 via an N1 interface. The WTRU 202 may communicate with other 5GC network functions (NFs) (e.g., SMF 216) using NAS transport via AMF 214 by means of dedicated (e.g., session management (SM) transparent containers, which the AMF may forward using the service based interface (SBI) to invoke Nsmf service. 3GPP has defined location services (LCS) feature over the user plane (UP) between WTRU 202 and the LMF 220.

Post quantum attack and PQC algorithms are described in the following. Quantum computing is set to change the dynamics of computing in the next decade. One major concern of post-quantum attack is the perfect forward secrecy attack by storing encrypted data now and decrypting it later using a quantum computer, which is also called “store-now-decrypt-later” or “harvest-now-decrypt-later” attack. Quantum computers threaten cryptography mainly through two powerful algorithms as of today: Shor's algorithm and Grover's search. Shor's algorithm can efficiently solve the problems of large integer factorization and discrete logarithms, making asymmetric key cryptography, such as RSA and ECC, highly vulnerable. On the other hand, Grover's search algorithm can speed up the search process, potentially impacting symmetric cryptography. However, it is currently considered infeasible even using mid-term quantum computers. Asymmetric key cryptography is much more vulnerable than symmetric key cryptography. According to expert estimates from the Global Risk Institute, there is a very high probability that within the next 25 to 30 years, quantum computers will be able to break RSA encryption with a 2048-bit key in just 24 hours.

Quantum-Safe Cryptography (QSC) is intended to protect the information exchange between individual users or data sources using algorithms that are resistant to attacks by both classical and quantum computers and keep this information secure even with the development of a mature quantum computing capability. The National Institute of Standards and Technology (NIST) initiated the process of the Post-Quantum Cryptography (PQC) standardization in 2017. As part of this initiative, NIST announced the standard candidates of five post-quantum cryptographic algorithms, respectively, for public-key encryption (i.e., CRYSTALS-Kyber and HQC) and digital signature (CRYSTALS-Dilithium, SPHINCS+ and FALCON). These algorithms are designed to resist against attacks leveraging quantum computing.

ML-KEM, also known as CRYSTALS-Kyber, is a lattice-based key encapsulation mechanism (KEM) designed for secure key exchange. Recently selected by NIST, HQC is a code-based key encapsulation mechanism that offers a stronger robustness than ML-KEM but with longer ciphertext. Module-lattice-based digital signature algorithm (ML-DSA), also known as CRYSTALS-Dilithium, is a lattice-based digital signature algorithm providing strong security and efficiency. Stateless hash-based digital signature algorithm (SLH-DSA), also known as SPHINCS+, is a stateless hash-based digital signature scheme which takes the advantages of avoiding dependence only on the security of lattices for signatures. Fast Fourier transform over N^{th} degree truncated polynomial ring unit (NTRU)-lattice-based digital signature algorithm (FN-DSA), also known as FALCON, is a lattice-based digital signature algorithm which takes the advantages of shorter public key size and signatures compared with other digital signature algorithms. Table 1 compares the security levels/categories of cryptographic algorithms and PQC algorithms. Generally, the higher security levels/categories, the longer the key size and the longer the ciphertext/signature.

TABLE 1
Comparison of Security Levels/Categories of
Cryptographic Algorithms and PQC Algorithms

| Security | AES/SHA (2/3) | |
|---|---|---|
| Level | Hardness | PQC Algorithms |
| 1 | AES-128 | ML-KEM-512, FN-DSA-512, |
| | | SLH-DSA-SHA2/SHAKE-128f/s |
| 2 | SHA-256/ | ML-DSA-44 |
| | SHA3-256 | |
| 3 | AES-192 | ML-KEM-768, ML-DSA-65, |
| | | SLH-DSA-SHA2/SHAKE-192f/s |
| 4 | SHA-384/ | No algorithm tested at this level |
| | SHA3-384 | |
| 5 | AES-256 | ML-KEM-1024, ML-DSA-87, |
| | | FN-DSA-1024, SLH-DSA-SHA2/ |
| | | SHAKE-256f/s |

Impact of quantum attacks to 3GPP systems is described in the following. The security threats posed by quantum technology to next generation network (e.g., 3GPP sixth generation system (6GS) are a concern. Symmetric and asymmetric cryptography are used widely in 5G system. For example, symmetric cryptography is used for the AKA protocol and the protection of the non-access stratum (NAS), access stratum (AS) and user plane (UP) on the air interface using 128-bit symmetric key algorithms. 3GPP standards working groups are enhancing cryptographic strength, and are focusing on symmetric 256-bit algorithms to bolster security to NIST security level 5.

Meanwhile, public key cryptography is used in various security domains, including network access security, network domain security and Service-Based Architecture (SBA) domain security, examples of which include SUPI protection, TLS-based SBI, OAuth, TLS-based N2 and N4 interfaces, and/or IPSec-based N3 interface, etc. Sixth generation (6G) 3GPP standards working groups will start work on introduction of PQC algorithms in 3GPP protocol specifications. Automatic terminal information service (ATIS) made recommendations for migrating 3GPP systems (e.g., 5GS) to be a future quantum-safe system (e.g., 6GS) with PQC protection across devices, WTRUs, RAN, core network (CN), and interconnect network. This may include expanding QSC to critical communication paths focusing on protecting the signature and authentication mechanisms across the 5G and 6G domains.

Solutions for WTRU-NF direct communications in 5G and potential 6G evolution are disclosed herein. 3GPP has defined mechanisms for communications over UP between WTRU and a termination point in the 5GC (e.g., LMF) for location services (LCS). 3GPP continues studying how to support standardized means of data transfer over UP between the WTRU and 5GC for WTRU data collection. The transfer and/or delivery of the trained model to the WTRU may also be part of the data transfer over UP. 3GPP is also studying a more flexible and unified system architecture for 6G which includes the following potential features but is not limited to: service-based RAN, which may allow RAN access and interact with the network services via SBI service-based UPF N4 interface; and/or WTRU-based SBI, which may enable the WTRU to access and interact with the network services provided by the NF via SBI, to a full service based network.

6G services between a WTRU and any 6G NF may go through UP-based or CP-based WTRU-NF communication. Efficient service management with finer granularity service flows, secure data transmission, especially to against quantum attacks, are needed in the 6GS for the operator to enable flexible, secure and cost-effective service delivery. Solutions are defined to provide end-to-end user plane protection between the WTRU and NF to address the security enhancement for WTRU-NF communication. To address the anticipated challenges posed by quantum attacks, the 6GS is expected to support enhanced secure end-to-end communication between the WTRU and NF. Solutions are defined to enable end-to-end PQC-based user plane protection to against the quantum attacks between WTRU and UPF, which may be extended to WTRU-NF PQC-based secure communication.

However, existing solutions address the use case of PDU session level protection or NF level protection. In other words, services/data transmitted between the WTRU and NF are treated with the same security configuration. However, in some scenarios, it may be desirable to cater to different services having different security requirements. For example, if some services are exchanging encrypted data on the application layer, encryption at the lower layer may be redundant (e.g., adding processing, energy consumption overhead). In another example, an NF may provide one or more services (e.g., A and B), whereby service A requires a lower security protection level than service B. Even when considering within a given service, the different types of data (e.g., service data flows (SDFs)) may require different security, such as for an augmented reality (AR)/extended reality (XR) or uncrewed aerial systems (UAS) service, user commands (e.g., aircraft remote control) may require higher security (e.g., data integrity) than the video/audio data.

It is therefore desirable for the 6GS to support a more flexible approach for the fine-grained secure end-to-end (E2) WTRU-NF communications. Finer security granularity may be needed to support differentiated security requirements across different services and including differentiated end-to-end security at a service level, SDF level, or quality of service (QoS) flow level. In order to accommodate a progressive transition to PQC-enabled security solutions, the following is considered in the solutions disclosed herein: enablement of fine-grained secure communications between WTRU and NF with a conventional approach (e.g., based on the network access security); and enablement of fine-grained secure communications between WTRU and NF with PQC protection.

Mechanisms are described herein where the system (e.g., 6GS) may enable fine-grained secure end-to-end (E2E) communication between a WTRU and an NF in the core network. In an example embodiment, the fine-grained secure E2E communication between WTRU and NF may be enabled at QoS flow-level or SDF-level. In this case, when the service data is transmitted over the UP between WTRU and NF, the service may be mapped to different QoS flows or SDF flows with different security configurations. In another example embodiment, fine-grained secure E2E communication between WTRU and NF may be enabled at a service-level. In this case, when the service data is transmitted over the control plane (CP) between WTRU and NF, different services may be configured with different security. In an example approach, one or more security key(s) (e.g., K_{SDF} (K_{QFI})/K_{Service}) used for fine-grained secure E2E communication between the WTRU and NF may be derived from an anchor key (e.g., K_{SEAF}) and/or or an intermediate key (e.g., K_{AUSF}) or a root key (e.g., K_{SF}).

In an example PQC based approach, security key(s) (e.g., K_{SDF} (or K_{QFI}) and/or K_{Service}) used for fine-grained secure E2E communication between a WTRU and NF may be derived from a Master Shared Secret Key (MSSK), which may be generated at the WTRU and/or NF during the PQC KEM encapsulation procedure. The PQC KEM procedure may be performed with or without the assistance of Security Function (SF). In an example, security key(s) (e.g., K_{SDF} (or K_{QFI}) and/or K_{Service}) may be derived using an existing procedure (e.g., Registration procedure, PDU session establishment procedure) or a new procedure (e.g., a new connection establishment procedure, as described herein) between the WTRU and NF.

Mechanisms are described herein where the system (e.g., 6GS) enables fine-grained secure end-to-end communication between a WTRU and an NF in the Core Network (e.g., a 6G core network (6GC)). In an example, the fine-grained secure E2E communication between WTRU and NF may be service-level secure communication. In this case, different services may be protected with different security configurations. This option may be applicable when the service data is transmitted over the control plane between WTRU and NF. In another example, the fine-grained secure E2E communication between WTRU and NF may be service data flow-level secure communication. In this case, the service data may be mapped to different service data flow (SDF), which may be protected with different security configurations (e.g., QoS flow-level secure communication). This option may provide even finer security granularity than service-level security, and may be applicable when the service data is transmitted over the user plane between WTRU and NF.

Example key derivation may be based on an approach where the K_{SDF} (K_{QFI})/K_{Service} is derived from an anchor key (e.g., K_{SEAF}), an intermediate key (e.g., K_{AUSF}) or a root key (e.g., K_{SF}). Example key derivation may be based on a PQC approach where the K_{SDF} (K_{QFI})/K_{Service} may be derived from a master shared secret key (MSSK), which may be generated at WTRU and/or NF during the PQC KEM encapsulation procedure. The procedure may be with or without the assistance of Security Function (SF). K_{QFI}/(K_{QFI}) and/or K_{Service} may be derived during a conventional procedure (e.g., registration, PDU session establishment) or a new procedure (e.g., connection establishment procedure as described herein) between WTRU and NF.

An example of fine-grained secure communications between a WTRU and NF using a non-PQC approach is described herein. In this example, a fine-grained secure end-to-end connection is established between WTRU and NF using a key distribution procedure. In an example, the WTRU may receive a message from AMF and/or SEAF with the SF information, which may include for example SF ID, SF name and/or fully qualified domain name (FQDN).

The WTRU may send a PDU session request message for setting up the SDF level (or QoS Flow level) security for the requested service. WTRU may include any of the following information in the PDU session request message: NF information (e.g., NF name, NF ID, NF address), service information (e.g., service name, service ID, service level token), SF information (e.g., SF address, SF ID, K_{SF} ID), and fine-grained security requirements (e.g., indications of whether confidentiality and/or integrity protection is preferred or optional or not needed). The WTRU may send a secure service connection request message to NF via the established PDU session for setting up the SDF level (or QoS Flow level) security for the requested service. The WTRU may send a secure service connection request message to NF via CP (e.g., new Nran to access SBI) for setting up the service level security for the requested service. The WTRU may include any of the following information in the secure service connection request message: NF information; service information; SF information; and fine-grained security requirements. The WTRU may send a secure service connection request message to NF via UP (e.g., the established PDU session) for setting up the SDF level (or QoS Flow level) security for the requested service.

The WTRU may receive from the SMF a response including fine-grained security profile. The fine-grained security profile may include, for example, any of the following: SDF filter used for NF to map the requested service data to one or more SDFs; SDF ID; security rules (e.g., confidentiality and/or Integrity protection for each SDF, and indicator of SDF level security or QoS Flow level security), and/or QoS Flow ID (QFI). The WTRU may receive from NF an indication of successful key derivation at NF and key lifetime via UP or CP. The WTRU may derive K_{NF} using root key K_{SF} and other parameters (e.g., WTRU ID, NF information) to guarantee the uniqueness of K_{NF}. WTRU may derive K_{SDF} (or K_{QFI})/K_{Service} using K_{NF} and other parameters (e.g., QFI, Service ID, SDF ID) to guarantee the uniqueness and key separation (e.g., on a flow or service level). The WTRU may derive K_{SDF} (or K_{QFI})/K_{Service} using K_{SF} and other parameters (e.g., Service ID, QFI, SDF ID) to guarantee the uniqueness and key separation (e.g., on a flow or service level). The WTRU may send indication of successful key derivation at WTRU to NF.

From the perspective of the NF, the NF may receive a session establishment/modification request message from SMF for setting up the SDF level (or QoS flow level) security for the requested service. The session establishment/modification request message may include any one or more of the following information: service information (e.g., Service name, Service ID, and service level token); SF information (e.g., SF address, SF ID, K_{SF} ID); fine-grained security profile (e.g., SDF filter used for NF to map the requested service data to one or more SDFs, SDF ID, and Security rules (e.g., Confidentiality and/or Integrity protection) for each SDF); and/or associated QFI.

The NF may receive the secure service connection request message from WTRU via the established PDU session for setting up the SDF level (or QoS flow level) security for the requested service. The secure service connection request message may include any one or more of the following information: NF information; service information; SF information; and fine-grained security requirements. NF information, Service information, SF information, and fine-grained security requirements are included in this message. The NF may receive a secure service connection request message from WTRU via CP (e.g., new Nran to access SBI, for setting up the Service level security for the requested service). The secure service connection request message may include any one or more of the following information: NF information; service information; SF information; and fine-grained security requirements.

The NF may receive from WTRU an indication of successful key derivation at WTRU via UP or CP. The NF may derive K_{NF} using K_{SF} and other parameters (e.g., WTRU ID, NF information) to guarantee the uniqueness of K_{NF}. The NF may derive K_{SDF} (or K_{QFI})/K_{Service} using K_{NF} and other parameters (e.g., QFI, Service ID, SDF ID) to guarantee the uniqueness and key separation (e.g., on a Flow or Service level). The NF may derive K_{SDF} (or K_{QFI})/K_{Service} using K_{SF} and other parameters (e.g., Service ID, QFI, SDF ID) to guarantee the uniqueness and key separation (e.g., on a flow or service level). The NF may send indication of successful key derivation at NF to WTRU.

An example of fine-grained secure communications between a WTRU and NF using a PQC protection is described herein. A WTRU may send a key request message to an SF for the NF PQC key. For example, if WTRU requests the PQC KEM encapsulation key for PQC algorithm (e.g., ML-KEM-512), the WTRU may include the WTRU ID, NF ID, PQC algorithm name (e.g., ML-KEM-512) and SF token in the key request message. The WTRU may receive a PQC key from SF for the requested NF PQC key. The WTRU may generate a MSSK and an “encapsulation” or ciphertext by using the NF PQC KEM encapsulation key. The WTRU may send a PDU session request message for setting up the SDF level (or QoS flow level) security for the requested service. Ciphertext or WTRU PQC encapsulation key is included in this message. The WTRU may send a secure service connection request message to NF via the established PDU session for setting up the SDF level (or QoS flow level) security for the requested service. The secure service connection request message may include Ciphertext or WTRU PQC encapsulation key. The WTRU may send a secure service connection request message to NF via CP (e.g., new Nran to access SBI), for setting up the service level security for the requested service. The secure service connection request message may include Ciphertext or WTRU PQC encapsulation key. The WTRU may derive K_{SDF} (or K_{QFI})/K_{Service} using MSSK and other parameters (e.g., Service ID, QFI, SDF ID) to guarantee uniqueness and key separation (e.g., on a Flow or Service level). The WTRU may receive from NF with Ciphertext via UP or CP.

From the perspective of the NF, the NF may receive a session establishment/modification request message from SMF for setting up the SDF level (or QoS flow level) security for the requested service. The session establishment/modification request message may include ciphertext or WTRU PQC encapsulation key. The NF may receive a secure service connection request message from WTRU via the established PDU session for setting up the QoS flow level security for the requested service. The secure service connection request message may include Ciphertext or WTRU PQC encapsulation key. The NF may receive secure service connection request message from WTRU via CP (e.g., new Nran to access SBI), for setting up the service level security for the requested service. The secure service connection request message may include Ciphertext or WTRU PQC encapsulation key. The NF may decapsulate MSSK using NF PQC KEM decapsulation key. The NF may derive K_{SDF} (or K_{QFI})/K_{Service} using MSSK and other parameters (e.g., QFI, Service ID, SDF ID) to guarantee uniqueness and key separation (e.g., on a Flow or Service level).

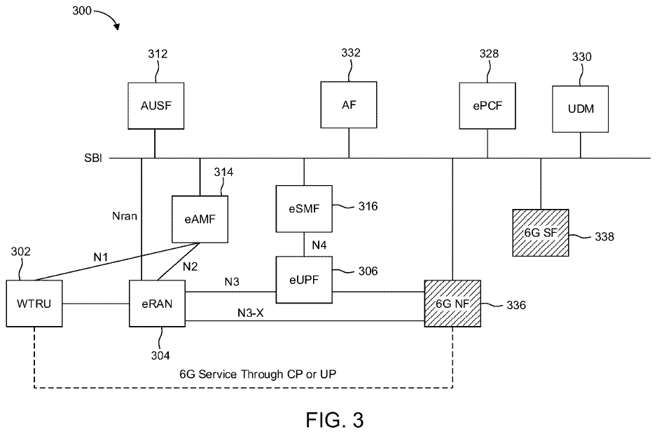

FIG. 3 is a system diagram illustrating an example 3GPP 6G system architecture 300 to support secure end-to-end WTRU-NF communications. The 6G system architecture 300 may include: WTRU 302; evolved radio access network (eRAN) 304; enhanced UPF (eUPF) 306; (6G) NF 336; enhanced AMF (eAMF) 314; enhanced SMF (eSMF) 316; (6G) SF 338; AUSF 312; AF 332; enhanced PCF (ePCF) 328; and UDM 330. The term “enhanced” may or may not be used interchangeably (e.g., eSMF 316 may also be referred to as SMF 316). A first option for CP connection (CP #1) includes the WTRU 302 using a conventional N1 interface for CP-terminated communication with legacy/evolved 5GS functions (e.g., MM, SM, PCF). In another option for CP connection (CP #2) the WTRU 302 uses RAN 304 as an SBI gateway for CP-terminated communications, via a new defined interface (e.g., Nran) to access to the SBI. In an example option for UP connection (UP #1), the WTRU 302 communicates using UP-based communications via UPF 306 (N3) with applicable new 6G NFs for, for example, data collection, sensing, positioning, etc. In another example option for UP connection (UP #2), the WTRU 302 communicates using UP-based communications directly with applicable new 6G NFs via a new defined interface (e.g., N3-X).

Signaling and service data traffic between WTRU and 6G NF can be transmitted via either CP or UP. Usually the CP-based WTRU-NF communication is not adapted for the high amount of data transfer foreseen for emerging new use cases such as artificial intelligence (AI)/machine learning (ML) or sensing. Services traffic via CP or UP may be preconfigured in WTRU and network or it may be dynamically configured based on the service type, data type, predicted data volume, etc. The WTRU may be configured by the network with a policy (e.g., during registration procedure or WTRU configuration update). Using the indication in the policy for given service (e.g., based on the service characteristics above), the WTRU may determine the communication path to select to communicate with the NF (CP or UP).

Example principles may support fine-grained security, such as service level security, SDF level security, and QoS flow level security. According to service level security, different services may be configured with different security configurations (e.g., Service 1 with confidentiality protection only, while Service 2 with both confidentiality and integrity protection). In example embodiments disclosed herein, service level security is applicable when the service data is transmitted via CP. According to SDF level security, SDFs are packets of WTRU-NF traffic used for a specific service, which are terminated at WTRU and NF (or an AF in the network). SDFs are typically identified by 5-tuples (e.g., source/destination IP addresses, source/destination port numbers, and the specific protocol in use) and associated with a QoS flow within a PDU session. The traffic data of one service may be mapped to one or more SDFs, and each SDF may be protected with different security configurations (e.g., for an AR service). The audio and video data may be mapped to SDF 1 and protected with confidentiality protection, while the user command may be mapped to SDF 2 and protected with both confidentiality and integrity protection. SDF 1 and SDF 2 may be mapped to the same QoS flow if they have the same QoS requirements. This option has even finer security granularity than the service level security, but it is only applicable when the services data is transmitted via UP.

According to QoS flow level security, instead of applying security on SDF level, security may be applied on QoS flow level. Unlike the existing QoS flow mapping mechanism where only QoS is considered, both QoS and security are considered in the mapping: SDFs with same QoS requirement but different security requirement will be mapped to different QoS flows (e.g., for an AR service). The audio and video data are mapped to SDF 1 and associated with QoS flow 1 which is protected with confidentiality protection, while the user command is mapped to SDF 2 and associated with QoS flow 2, which is protected with both confidentiality and integrity protection, even though both SDF1 and SDF2 have the same QoS requirements.

An example 6G SF is described in the following. For key generation/derivation, a 6G SF may provide key material that is used to establish secure communication between the WTRU and the NF. Using SF key management operations, WTRU can establish a security association with the NF at either NF/service level (service via CP) or SDF/QoS flow level (service via UP). For key storage, in a non-PQC approach, a 6G SF may store a root key for the WTRU and NF. For a PQC approach, the 6G SF may store the PQC information, for example supported PQC algorithms and corresponding public keys, for WTRU and UF.

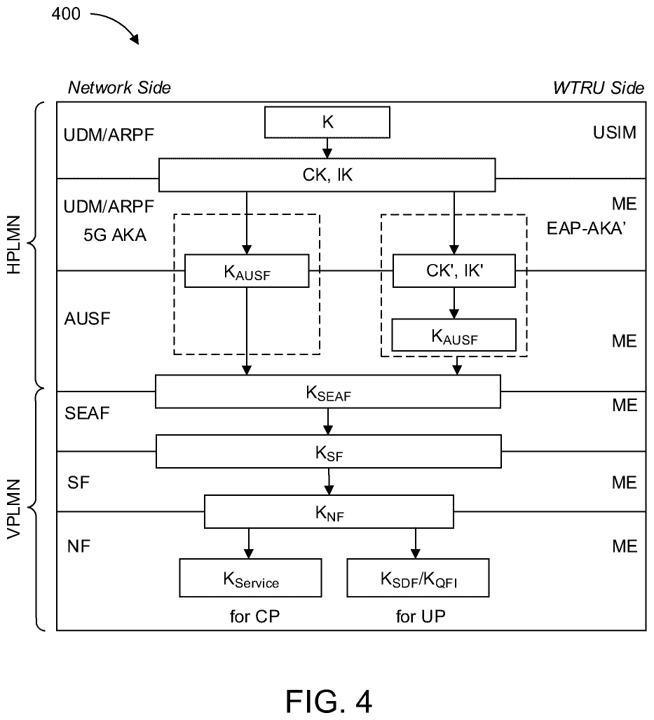

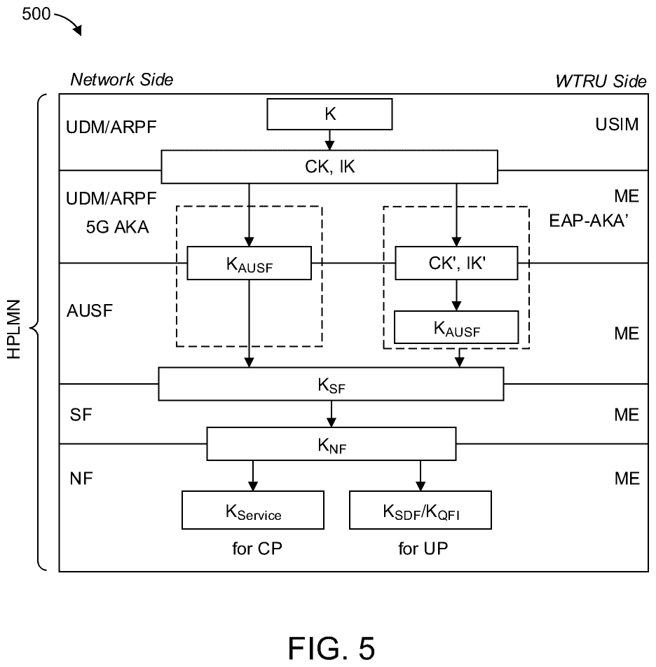

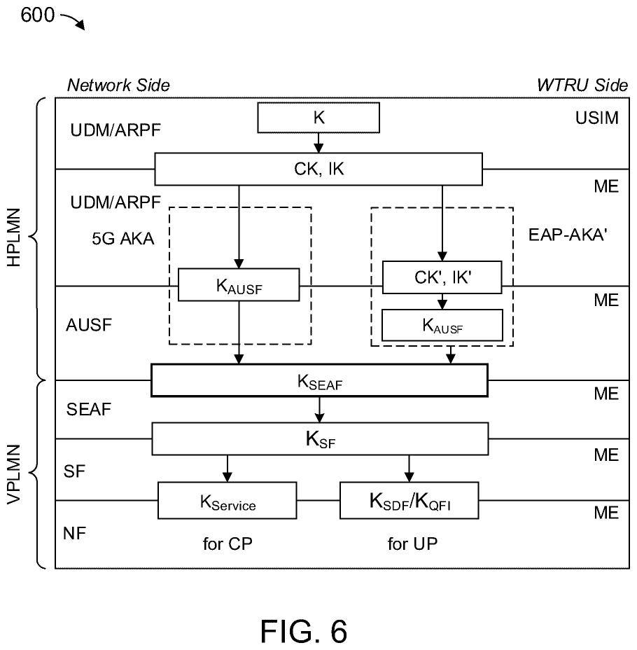

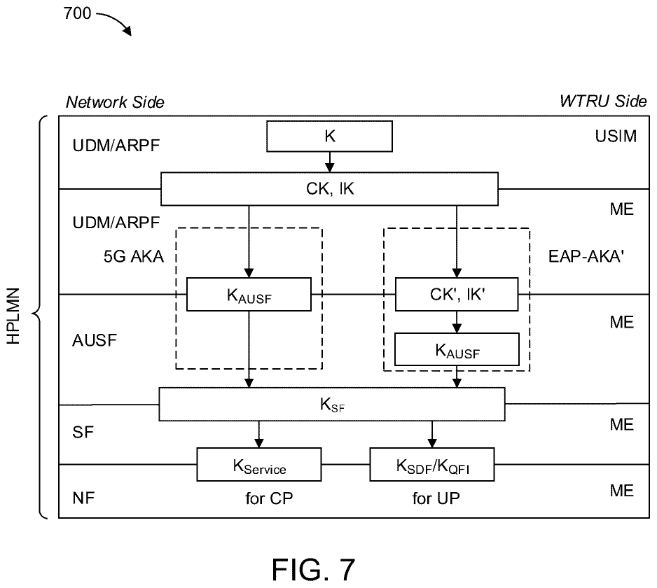

Example fine-grained secure communications between a WTRU and NF using a non-PQC approach are described herein. Different key hierarchy options for the support of fine-grained secure communications between WTRU and NF using a conventional (non-PQC) approach are described herein. FIG. 4 is a hierarchical diagram illustrating an example key hierarchy-1a 400 (K_{Service}/K_{SDF} (or Kor), wherein the key hierarchy 400 is derived from K_{NF}, E2E communications between WTRU and NF in visited public land mobile network (VPLMN). FIG. 5 is a hierarchical diagram illustrating an example key hierarchy-1b 500 (K_{Service}/K_{SDF} (or K_{QFI}), wherein the key hierarchy 500 is derived from K_{NF}, E2E Communications between WTRU and NF in home public land mobile network (HPLMN). FIG. 6 is a hierarchical diagram illustrating an example key hierarchy-2a 600 (K_{Service}/K_{SDF} (or K_{QFI}), wherein the key hierarchy 600 is derived from K_{SF}, E2E Communications between WTRU and NF in VPLMN. FIG. 7 is a hierarchical diagram illustrating an example key hierarchy-2b 700 (K_{Service}/K_{SDF} (or K_{QFI}), wherein the key hierarchy 700 is derived from K_{SF}, E2E Communications between WTRU and NF in HPLMN.

After each successful primary authentication, the AUSF or SEAF may provide the SF with a root key (K_{SF}) and associated unique key identifier (K_{SF} ID) used as a root of security for communications between WTRU and NFs. The K_{SF} may be derived from an anchor key (e.g., K_{SEAF}) or an intermediate key (e.g., K_{AUSF}). K_{SF} and K_{SF} ID pair (i.e., <K_{SF}, K_{SF} ID>), may be unique for each WTRU. For one WTRU, there may be multiple <K_{SF}, K_{SF} ID> pair provided and stored in 6G SF. To enable a fine-grained secure connection establishment between the WTRU and an NF, there are two ways to derive the shared key for one service or for one SDF/QoS flow, as described below.

According to key hierarchy #1 (as illustrated in FIG. 4 and FIG. 5), a shared key K_{NF} and an identifier (i.e., K_{NF} ID), may be derived at the SF and WTRU using the root key (K_{SF}). The SF may guarantee the K_{NF} is unique for each NF. <K_{NF}, K_{NF} ID> pair may be sent to NF. NF and WTRU may continue to use K_{NF} to derive the unique shared key for the requested service, for example if the service data is transmitted via CP, a shared key (i.e., K_{Service}) may be derived for the requested service. If the service data is transmitted via UP and mapped to one or more SDFs, one or more SDF level keys (i.e., K_{SDF}) may be derived (one K_{SDF} for one SDF). FIGS. 4 and 5 show the different use cases. FIG. 4 shows the use case of E2E communications between WTRU and NF in VPLMN (Key hierarchy-1a) and FIG. 5 shows the use case of E2E Communications between WTRU and NF in HPLMN (Key hierarchy-1b).

According to key hierarchy #2 (as illustrated in FIG. 6 and FIG. 7), a shared key is derived at the SF and WTRU using K_{SF} directly for the requested service. Like key hierarchy #1, K_{Service} may be derived for the requested service if the service data is transmitted via CP. One or more SDF level keys (i.e., K_{SDF}) may be derived for different SDFs if the service is transmitted via UP and mapped to one or more SDFs. FIGS. 6 and 7 show the different use cases. FIG. 6 shows the use case of E2E Communications between WTRU and NF in VPLMN (Key hierarchy-2a) and FIG. 7 shows the use case of E2E Communications between WTRU and NF in HPLMN (Key hierarchy-2b). The WTRU and NF may use K_{Service} or K_{SDF} (or K_{QFI}) as a pre-shared key (PSK) to further derive the encryption key and/or integrity key (not shown in the figures) for data confidentiality and integrity protection.

To guarantee the uniqueness of the shared key, any one or more of the following parameters may be used for the key derivation: NF name, indicating the name of the NF (e.g. ‘PCF’, ‘NWDAF’, ‘UPF’) that the WTRU wishes to connect to; NF ID; NF address (e.g., FQDN); service name indicating the name of the service (e.g., “Model Training”, “Location Analysis”, “Data Transmission”, “Object Detection”, etc.); service ID; NF instance ID; SDF ID; QoS flow ID; one or more freshness parameters, which may comprise a pair of nonces exchanged between WTRU and network during the WTRU-NF communication establishment; a counter maintained at WTRU and network (e.g., count of number of WTRU NF connections incremented at WTRU and SF); and/or WTRU ID, which may be SUPI or GUTI for example. Different example scenarios of fine-grained secure E2E Communication setup is described in detail herein, and summarized in Table 2.

TABLE 2
Example scenarios of fine-grained secure E2E communication setup

| Service data is | Signaling between WTRU | Who initiates | |
|---|---|---|---|
| transmitted over | and network | the procedure | Fine-grained Security |
| User Plane | N1 (conventional NAS) | WTRU | SDF level/QoS Flow level Security |
| User Plane | UP | WTRU | SDF level/QoS Flow level Security |
| Control Plane | CP (new NAS via Nran) | WTRU | Service level Security |
| User Plane | N1 (conventional NAS) | AF | SDF level/QoS Flow level Security |

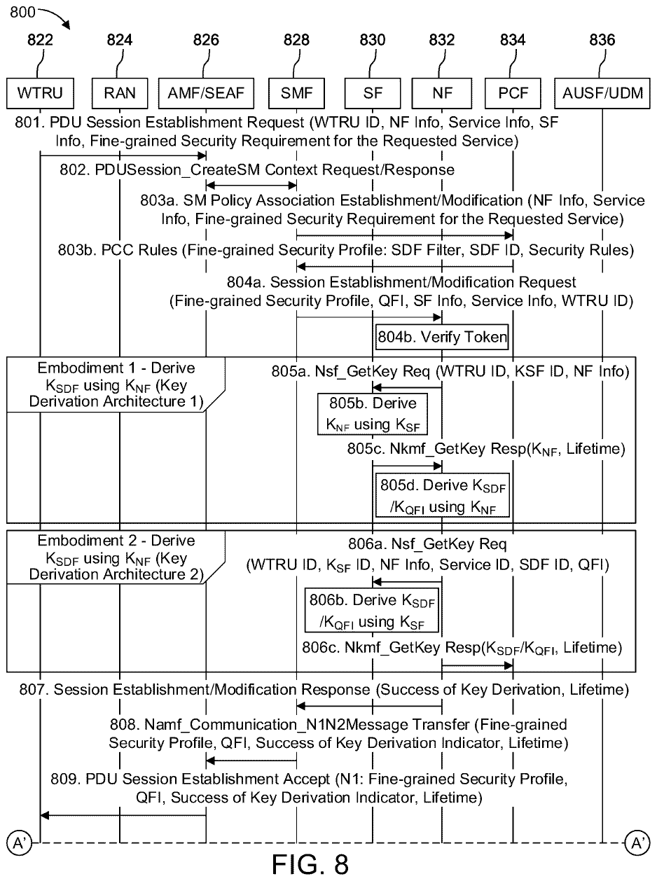

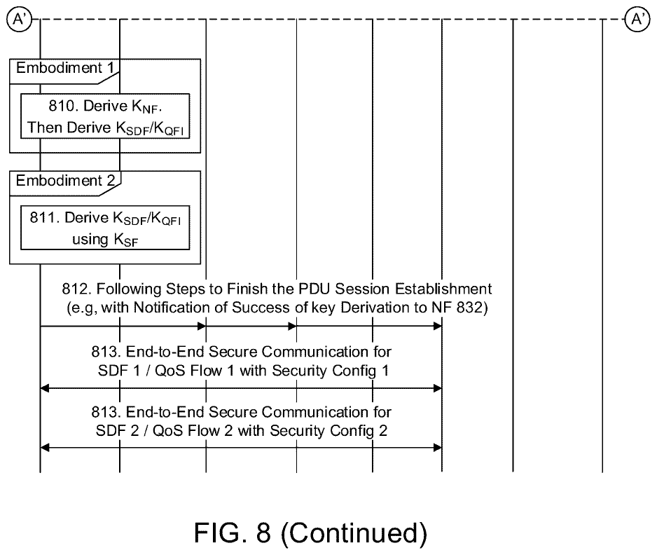

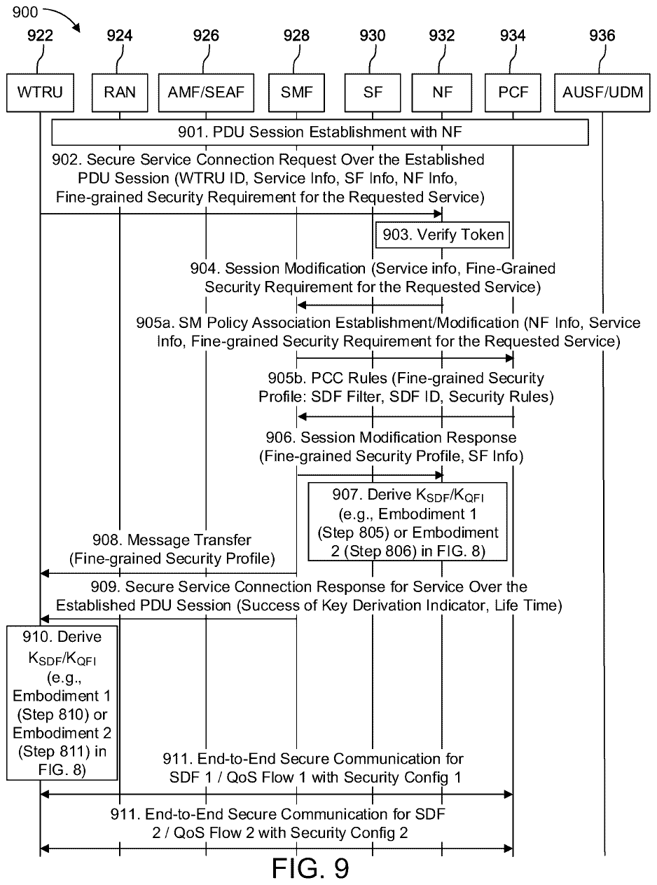

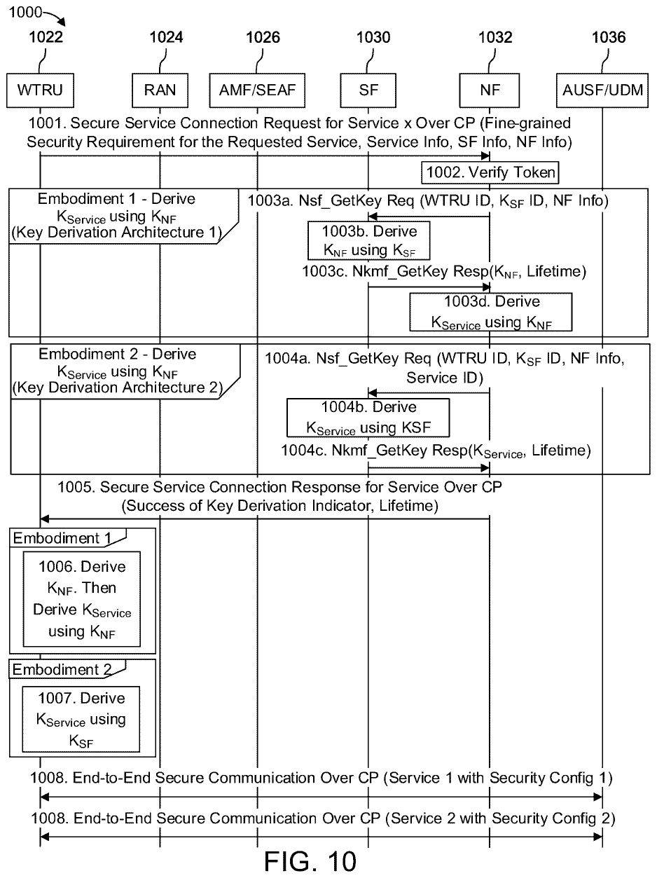

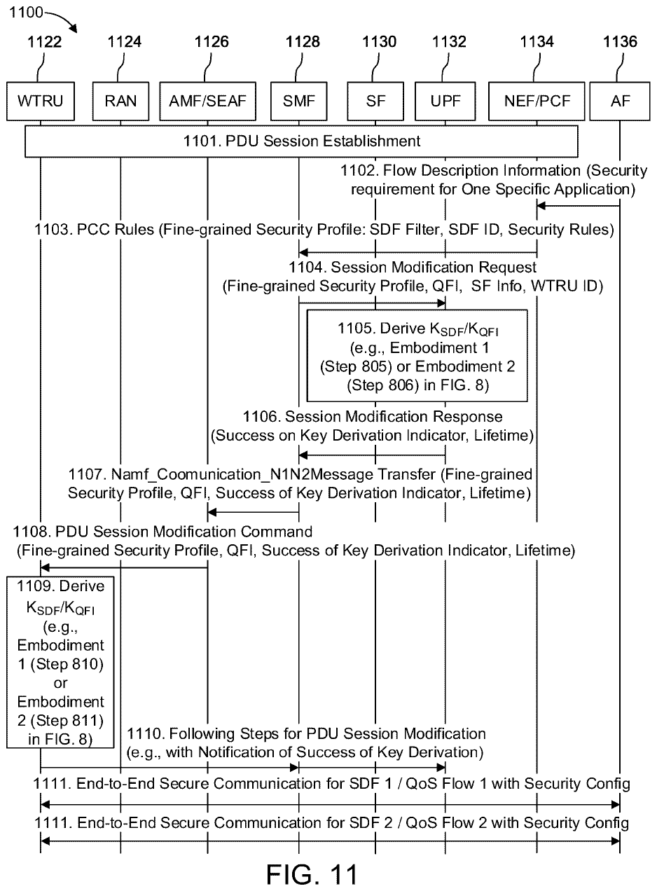

Example procedures for WTRU-NF fine-grained secure E2E user plane communication setup during PDU session establishment are described herein. FIG. 8 is a flow diagram illustrating an example WTRU-NF fine-grained secure E2E user plane communication setup procedure 800 during PDU session establishment. Procedure 800 may be used by a WTRU 822 to establish fine-grained secure E2E user plane communication with NF 832 in VPLMN or HPLMN during PDU session establishment, which may be based on network access security. The example system may include: WTRU 822; RAN 824 (e.g., base station); AMF/SEAF 826; SMF 828; SF 830; NF 832; PCF 834; and AUSF/UDM 836. WTRU 822 and network (e.g., AMF/SEAF 826 or AUSF 836) may generate a root key pair <K_{SF}, K_{SF} ID> after successful primary authentication. WTRU 822 may discover services provided by the NF 832. The requested service data may be transmitted via user plane and mapped to one or more SDFs with different security configurations. There may be multiple K_{SDF} for different SDFs (e.g., K_{SDF-x} for SDF x and K_{SDF-y} for SDF y). The WTRU 822 and NF 832 may secure the SDFs with different K_{SDF}. FIG. 8 illustrates two example embodiments of how K_{SDF} is derived by using the key derivation architecture 1 and 2 described above.

A first prerequisite is that WTRU 822 may obtain the NF information including NF ID, NF address, end-to-end WTRU-NF communication security capability (e.g., the supported security protocols and algorithms), and supported services by the NF 832 (e.g., service ID, service name and security requirements for that service, such as whether confidentiality and/or integrity protection is preferred or optional or not needed, and the required security level if protection is required). Another prerequisite is that WTRU 822 may get service information including service name, service ID and service-level token. Another prerequisite is that WTRU 822 and SF 830 have <K_{SF}, K_{SF} ID> pair stored.

At 801, WTRU 822 may send PDU session establishment request message to AMF 826 for the requested service. The PDU session establishment request message may include: WTRU ID, NF information (e.g., NF name, NF ID, NF address), service information (e.g., service name, service ID, service-level token), SF information (e.g., SF ID, SF name, SF address), and/or security requirement for the requested service (e.g., whether confidentiality and/or integrity protection is preferred or optional or not needed, and the required security level if protection is required). At 802, upon receiving the above parameters from AMF 826, the SMF 828 checks that whether the PDU session with fine-grained user plane security is allowed based on session management subscription data and sends a response to AMF 826 accordingly.

At 803a, SMF requests a policy association establishment or modification to PCF indicating a fine-grained E2E user plane connection for the requested service and security requirement for the connection. At 803b, The SMF 828 receives PCC rules from the PCF 834 including the fine-grained security profile that may include any one or more of the following information: SDF filter (e.g., 5-Tuples, used by NF to filter the specific service data of the requested service, and map it to one SDF); SDF ID; and/or security rules (e.g., whether to apply confidentiality and/or Integrity protection for this SDF, indicator of SDF level security or QoS Flow level security).

At 804a, the SMF 828 sends a request message to the NF 832 for a session setup, such that the request message may include any one or more of the following information: a set of fine-grained security profile, received in step 803, and the associated QoS Flow ID (QFI); WTRU ID; service information (e.g., service name, service ID, service-level token); and/or SF information (e.g., SF address, SF ID, K_{SF} ID). At 804b, upon receiving the request message from SMF 828, NF 832 verifies the service-level token to make sure WTRU 822 has the authority to access the service.

Steps 805a-805d illustrate embodiment 1 of how to derive K_{SDF}/K_{QFI} at NF 832 using key derivation architecture 1 (e.g., Derive K_{NF} using K_{SF} and then derive K_{SDF}/K_{QFI} using K_{NF}). At 805a, NF 832 sends GetKey request message include any of the following information: WTRU ID, K_{SF} ID and NF information (NF name, NF ID, etc.). At 805b, SF 830 derives K_{NF} using K_{SF} and other parameters to guarantee the uniqueness of K_{NF}. At 805c, SF 830 sends GetKey response to NF 832 with the derived K_{NF} and key lifetime of K_{NF}. At 805d, NF 832 derives K_{SDF}/Kor using K_{NF} and other parameters (e.g., Service ID, SDF ID, QFI) to guarantee uniqueness.

Steps 806a-806c illustrate embodiment 2 of how K_{SDF}/K_{QFI} is derived at NF 832 using key derivation architecture 2 (Derive K_{SDF}/K_{QFI} using K_{SF}). At 806a, NF 832 sends GetKey request message including any of the following information: WTRU ID, K_{SF} ID, NF information (NF name, NF ID, etc.) and service information (e.g., service ID). At 806b, SF 830 derives K_{SDF}/Kor using K_{SF} and other parameters (e.g., Service ID, SDF ID, QFI) to guarantee uniqueness. 806c, SF 830 sends GetKey response message to NF 832 with the derived K_{SDF}/K_{QFI} and associated key lifetime.

At 807, NF 832 sends a response message to SMF 828 with indication of the success of key derivation and key lifetime. At 808, SMF 828 sends a message to AMF 826 including information (e.g., N1 SM information) for WTRU 822 via AMF 826 and RAN 824 (e.g., base station or gNB, such that the information may include the fine-grained security profile. At 809, AMF 826 forwards the received information in step 808 to WTRU 822.

Step 810 illustrates embodiment 1 of how K_{SDF}/K_{QFI} is derived at WTRU 822 using key derivation architecture 1 (derive K_{NF} using K_{SF} and then derive K_{SDF}/K_{QFI} using K_{NF}). At 810, WTRU 822 derives K_{NF} and then WTRU 802 derives K_{SDF}/K_{QFI} using K_{NF} and other parameters (e.g., Service ID, SDF ID, QFI) to guarantee uniqueness. Step 811 illustrates embodiment 2 of how K_{SDF}/K_{QFI} is derived at WTRU 822 using key derivation architecture 2 (derive K_{SDF}/K_{QFI} using K_{SF}). At 811, WTRU 822 derives K_{SDF}/Kori using K_{SF} and other parameters (e.g., Service ID, SDF ID, QFI) to guarantee the uniqueness.

At 812, WTRU 812 and the network entities finish PDU session establishment. The WTRU 822 may send a notification of success of key derivation to NF 832. At 813, WTRU 822 and NF communicate securely end-to-end for the specific SDF over the UP connection, for example, SDF 1 is protected with security configuration 1 (confidentiality) and SDF 2 is protected with security configuration 2 (integrity). Alternatively, WTRU and NF 832 communicate securely end-to-end for the specific QoS flow over the UP connection. In an example, QoS flow 1 is protected with security configuration 1 (e.g., confidentiality) and QoS flow 2 is protected with security configuration 2 (e.g., integrity).

FIG. 9 is a flow diagram illustrating an example WTRU-NF fine-grained secure E2E user plane communication setup procedure 900 via UP. Procedure 900 may be used by WTRU 922 to establish fine-grained secure E2E user plane communication with NF 932 in VPLMN or HPLMN via UP, which is based on network access security. The example system may include: WTRU 922; RAN 924 (e.g., base station); AMF/SEAF 926; SMF 928; SF 930; NF 932; PCF 934; and AUSF/UDM 936.

In procedure 800 of FIG. 8 and procedure 900 of FIG. 9, the service data transmission is over the user plane, with SDF level security or QoS flow level security. A difference procedure 800 of FIG. 8 and procedure 900 of FIG. 9 is that in FIG. 8, the fine-grained secure E2E communication is established during the PDU session establishment procedure, while in FIG. 9, a PDU session is already established and the signaling transmission to establish the fine-grained secure E2E user plane communication is sent through the UP. Similarly, FIG. 9 also shows two embodiments of how K_{SDF}/K_{QFI} is derived by using the key derivation architectures 1 and 2. The prerequisites listed for procedure 800 in FIG. 8 may also apply to procedure 900 in FIG. 9.

With reference to procedure 900 in FIG. 9, at 901, a PDU session is established between WTRU 922 and NF 932. At 902, WTRU 922 sends a secure service connection request message to the NF 932 over UP (e.g., the established PDU session). The secure service connection request message may include any of the following information: WTRU ID; NF information (e.g., NF name); service information (e.g., service name, service ID, service-level token); SF information; and/or security requirement for the requested service (e.g., whether confidentiality and/or integrity protection is preferred or optional or not needed). At 903, NF 932 verifies the service-level token firstly to make sure WTRU 922 has the authority to access the service. At 904, NF 932 sends session modification request message to SMF 928 indicating that a fine-grained secure E2E UP connection for the requested service with security requirement for the connection and NF security capabilities. Steps 905a and 905b are the same as steps 803a and 803b of FIG. 8.

At 906, the SMF 928 sends session modification response message to the NF 932 with any of the following information: a set of fine-grained security profile, received in step 905b, and the associated QoS Flow ID (QFI); and/or SF information (e.g., SF address, SF ID, K_{SF} ID). Step 907 is the same as steps 805a-805d and steps 806a-806c in FIG. 8, such that there are two embodiments for NF 932 to derive K_{SDF}/K_{QFI} for different SDFs/QoS flows. At 908, SMF 928 sends a message to WTRU 922 including fine-grained security profile (refer to steps 803a and 803b of FIG. 8). At 909, NF 932 sends a secure service connection response message to the WTRU 922 via UP indicating the successful service key derivation at NF 932 and associated key lifetime. Step 910 is the same as steps 810 and 811 in FIG. 8, such that there are two embodiments to derive K_{SDF}/K_{QFI} at WTRU 922 for different SDFs/QoS flows. Step 911 is the same as step 813 of FIG. 8.

In an example, NF 932 may initiate the WTRU-NF fine-grained secure E2E communication over UP (e.g., the established PDU session). NF 932 may contact PCF 934 (via SMF 928) to obtain the fine-grained security profile and then forward the fine-grained security profile to WTRU 922. Both NF 932 and WTRU 922 may derive the shared key to setup the fine-grained user plane security.

FIG. 10 is a flow diagram illustrating an example WTRU-NF fine-grained secure E2E communication setup procedure 1000 via CP. Procedure 1000 may be used by WTRU 1022 to establish fine-grained secure E2E communication with NF 1032 in VPLMN or HPLMN over CP, which is based on network access security. The example system may include: WTRU 1022; RAN 1024 (e.g., base station); AMF/SEAF 1026; SF 1030; NF 1032; and AUSF/UDM 1036.

A difference between the procedure 1000 of FIG. 10 and procedures 800 and 900 of FIGS. 8 and 9 is that in FIGS. 8 and 9 the service data transmission between WTRU and NF is over user plane (i.e., it is SDF level or QoS flow level security). In contrast, in FIG. 10, the service data transmission is over control plane (i.e., it is service-level security). FIG. 10 also shows two embodiments of how K_{Service} is derived by using the key derivation architectures 1 and 2. The prerequisites listed for procedure 800 in FIG. 8 may also apply to procedure 1000 in FIG. 10.

With reference to procedure 1000 in FIG. 10, at 1001 WTRU 1022 send a secure service connection request message to the NF 1032 over CP (e.g., via Nran, or via N1 to access to SBI). The secure service connection request message may include any of the following information: WTRU ID; NF information (e.g., NF name, NF ID); service information (e.g., service name, service ID, service-level token); SF information; and security requirement for the requested service (e.g., whether confidentiality and/or integrity protection is preferred or optional or not needed; and the required security level if protection is required). At 1002, NF 1032 verifies the service-level token firstly to make sure WTRU 1022 have the authority to access the service.

Steps 1003a-1003d illustrate embodiment 1 of how K_{Service} is derived at NF 1032 using key derivation architecture 1 (derive K_{NF} using K_{SF} and then derive K_{Service} using K_{NF}). At 1003a, NF 1032 sends GetKey request message including any of the following information: WTRU ID; K_{SF} ID; and/or NF information (NF name, NF ID, etc.). At 1003b, SF 1030 derives K_{NF} using K_{SF} and other parameters to guarantee the uniqueness of K_{NF}. At 1003c, SF 1030 sends GetKey response message to NF 1032 with the derived K_{NF} and associated key lifetime. At 1003d, NF 1032 derives K_{Service} using K_{NF} and other parameters (e.g., Service ID) to guarantee the uniqueness of K_{Service}.

Steps 1004a-1004c illustrate embodiment 2 of how K_{Service} is derived at NF 1032 using key derivation architecture 2 (derive K_{Service} using K_{SF}). At 1004a, NF 1032 sends GetKey Request message including any of the following information: WTRU ID; K_{SF} ID; NF information (NF name, NF ID, etc.); and/or service information (e.g., service ID). At 1004b, SF 1030 derives K_{Service} using K_{SF} and other parameters (e.g., Service ID) to guarantee the uniqueness of K_{Service}. At 1004c, SF 1030 sends GetKey Response message to NF 1032 with the derived K_{Service} and associated key lifetime. At 1005, NF 1032 sends a secure service connection response message to the WTRU 1022 over CP indicating the successful service key derivation at NF 1032 and associated key lifetime.

Step 1006 illustrates embodiment 1 of how K_{Service} is derived at WTRU 1022 using key derivation architecture 1 (derive K_{NF} using K_{SF} and then derive K_{Service} using K_{NF}). At 1006, WTRU 1022 derives K_{NF} using K_{SF} and other parameters (e.g., WTRU ID, NF information) to guarantee the uniqueness of K_{NF}. The WTRU 1002 also derives K_{Service} using K_{NF} and other parameters (e.g., Service ID) to guarantee the uniqueness of K_{Service}.

Step 1007 illustrate embodiment 2 of how K_{Service} is derived at WTRU 1022 using key derivation architecture 2 (derive K_{Service} using K_{SF}). At 1007, WTRU 1022 derives K_{Service} using K_{SF} and other parameters (e.g., Service ID) to guarantee the uniqueness of K_{Service}. At 1008, WTRU 1022 and NF 1032 communicate securely end-to-end for the specific service over the CP connection. For example, Service 1 is protected with security configuration 1 (e.g., confidentiality) and Service 2 is protected with security configuration 2 (e.g., integrity).

In an example, NF 1032 may initiate the WTRU-NF fine-grained secure E2E communication over CP. NF 1032 may contact PCF (via SMF, not shown) to obtain the fine-grained security profile and then forward the profile to WTRU 1022. Both NF 1032 and WTRU 1022 may derive the shared key to set up the fine-grained security for the services transmitted via CP.

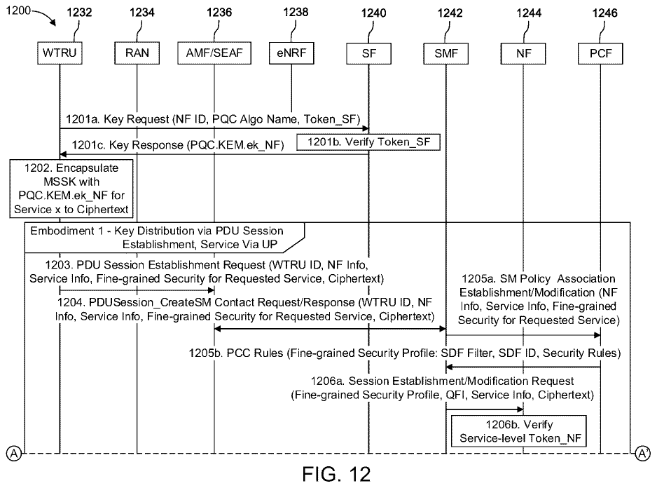

FIG. 11 is a flow diagram illustrating an example AF requested WTRU-NF fine-grained secure E2E UP communication establishment procedure 1100. Procedure 1200 may be used establish fine-grained secure E2E UP communication between WTRU 1122 and UPF 1132, which may be triggered by AF 1136. 3rd party services may have different security requirements for the service data flows. The example system may include: WTRU 1122; RAN 1124 (e.g., base station); AMF/SEAF 1126; SMF 1128; SF 1130; UPF 1132; NEF/PCF 1134; and AF 1136.

The security requirement may be carried in the flow description information, along with the QoS requirement, and may be sent from AF 1136 to PCF 1134. PCF 1134 may generate the PCC rules and may send the PPC rules to SMF 1128. SMF 1128 may initiate the session modification with UPF 1132 and may forward the fine-grained security profile to UPF 1132. UPF 1132 may map the specified service/application data to SDFs and may protect that SDFs based on the security rules carried in the fine-grained security profile. UPF 1132 may retrieve the security keys from SF 1130.

At 1101, a PDU session is established between WTRU 1122 and UPF 1132. At 1102, on behalf of a third party application for example, the AF 1136 may provide flow description information (e.g. source and destination IP address, port numbers, the protocol information, and/or corresponding QoS and security requirement for the specified service) and may send the flow description information to PCF 1134 to enable the binding functionality and the generation or selection of the SDF filter(s) in the PCC rules. The security requirements may include, but are not limited to, any of the following example requirements: whether confidentiality protection is preferred or whether it is optional or whether it is not needed for a service data flow; whether integrity protection is preferred or whether it is optional or whether it is not needed for a service data flow; and/or preferred security algorithms.

At 1103, PCF 1134 may generate or select a PCC rule containing fine-grained security profile (e.g., SDF filter(s) either as IP Packet Filter set or as Ethernet Packet Filter set derived from the Flow Description information, along with the SDF ID and security rules, such as confidentiality protection with the selected security algorithm is preferred for the SDF and indicator of SDF level security or QoS flow level security). PCF 1134 sends the PCC rules to SMF 1128. At 1104, SMF 1128 may associate the PCC rules with a QoS flow. SMF 1128 may initiate a session establishment/modification procedure with UPF 1132 and send a session modification request message to UPF 1132 including any of the following information: the fine-grained security profile; QFI. UPF 1132 may use the SDF filter to map the specified service to SDFs that is protected based on the security rules. The session modification request message may also include the SF information (e.g., SF ID, SF address, K_{SF} ID) and/or WTRU ID to help the UPF 1132 to locate the K_{SF} at SF 1130. Step 1104 is the same as steps 805a-805d or steps 806a-806c in FIG. 8, such that there are two embodiments for UPF 1132 to derive K_{SDF}/K_{QFI}.

At 1106, UPF 1132 may send session modification response message to SMF 1128 with an indication that the successful key derivation and associated key lifetime. At 1107, SMF 1128 may send a message to AMF 1126 including information (e.g., N1 SM information) for WTRU 1122 via AMF 1126 and RAN 1124 (e.g., gNB or base station), including the fine-grained security profile. At 1108, AMF 1126 may forward the received information (e.g., in a PDU session modification command message) to WTRU 1122. Step 1109 may be the same as step 810 or step 811 in FIG. 8, such that there are two embodiments to derive K_{SDF} at WTRU 1122 for different SDFs. At 1110, the WTRU and NFs follow steps to finish the PDU session modifications procedures. The WTRU 1122 may also send a notification message of success of key derivation to UPF 1132. At 1111, WTRU 1122 and UPF 1132 may communicate securely end-to-end for the specified SDFs over the UP connection.

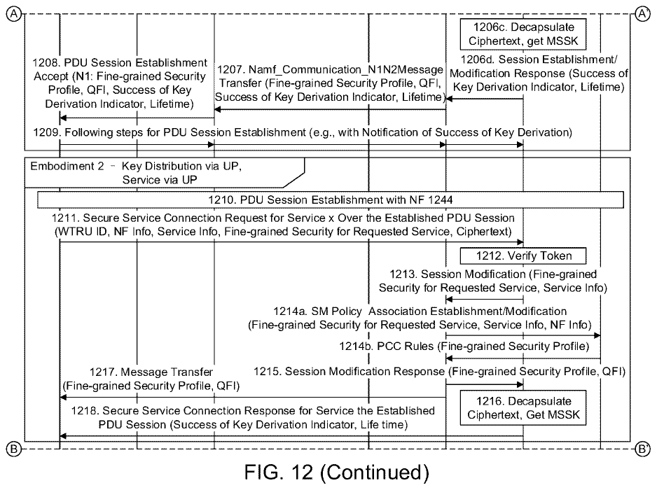

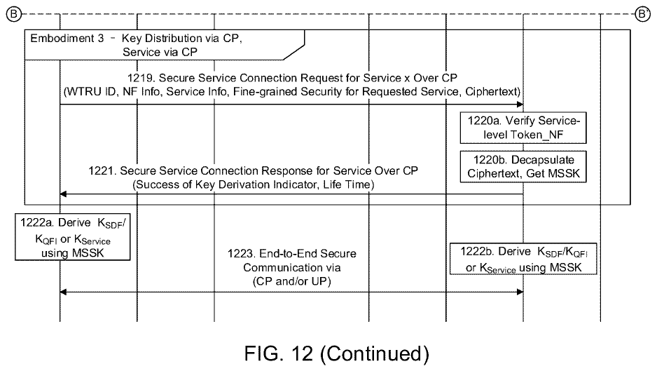

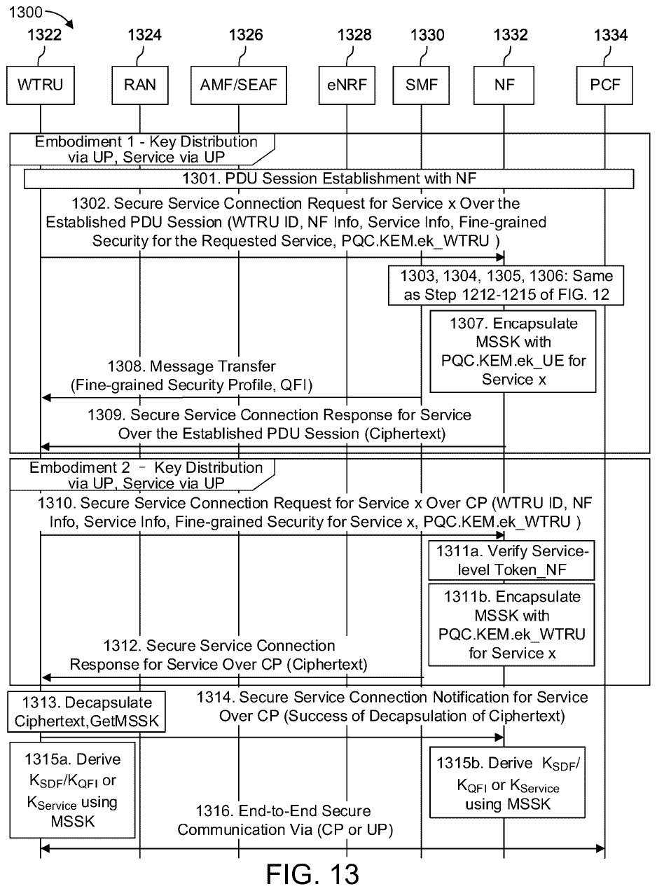

Example procedures for fine-grained secure communications between WTRU and NF with PQC protection are disclosed herein. FIG. 12 is a flow diagram illustrating an example WTRU requested PQC-based WTRU-NF fine-grained secure E2E communication establishment procedure 1200 via SF 1240. Procedure 1200 may be used by the WTRU 1232 to establish fine-grained secure E2E communication with NF 1244, which may be based on PQC protection. The example system may include: WTRU 1232; RAN 1234 (e.g., base station); AMF/SEAF 1236; enhanced network repository function (NRF) (eNRF) 1238; SF 1240; SMF 1242; NF 1244; and PCF 1246.

An example prerequisite is that NF 1244 may register its end-to-end WTRU-NF communication security capability (e.g., the supported security protocols and algorithms, including conventional algorithms and PQC algorithms) at for example the eNRF 1238. If NF 1244 supports PQC algorithms, the NF 1244 may store the PQC information (e.g., algorithm name and key) at SF 1240 that may be indexed by NF ID. Examples of PQC information may include any of the following: PQC Algorithm name-1: ML-KEM-512, which is a lattice-based key encapsulation algorithm; encapsulation key-1: PQC.KEM.ek_NF1 (encapsulation key which is an 800-bytes array); PQC algorithm name-2: ML-KEM-1024, which is a lattice-based key encapsulation algorithm; encapsulation key-2: PQC.KEM.ek_NF2 (encapsulation key which is a 1568-bytes array); PQC algorithm name-3: FN-DSA-512, which is lattice-based digital signature algorithm; and/or public key-3: PQC.DSA.pk_NF3 (public key which is an 897-bytes array). Another prerequisite is that WTRU 1232 may obtain NF information (e.g., NF name, NF ID, NF address) and service information (e.g., service name, service ID and service-level token).

At 1201a, WTRU 1232 may send a key request message to SF 1240 for the PQC key of the selected NF 1244. For example, if WTRU 1232 requests the PQC KEM encapsulation key for PQC algorithm (e.g., ML-KEM-512), the key request message may include any of the following information: NF ID, PQC algorithm name (e.g., ML-KEM-512), and/or SF token. At 1201b, the SF 1240 may verify the token. At 1201c, SF 1240 may send a key response message including the requested PQC key to WTRU 1232. At 1202, WTRU 1232 may generate a MSSK and an “encapsulation” or ciphertext by using the received NF PQC KEM encapsulation key.

Step 1203-1209 illustrate example embodiment 1, such that the MSSK is distributed via PDU session establishment, and service data is transmitted over UP. At 1203, WTRU 1232 may send a PDU session establishment request message to AMF 1236 for the requested service. The PDU session establishment request message may include any of the following information: WTRU ID; NF information (e.g., NF name, NF ID, NF address); service information (e.g., service name, service ID, service-level token); ciphertext; and/or security requirement for the requested service (e.g., whether confidentiality and/or integrity protection is preferred or optional or not needed; and the required security level if protection is required, PQC-based key distribution is required, and preferred security level).

At 1204, in response to receiving the above parameters from AMF 1236, the SMF 1242 may check whether the PDU session with fine-grained UP security is allowed based on session management subscription data and the SMF 1242 may send a response message to AMF 1236 accordingly. Steps 1205a and 1205b may be the same as steps 803a and 803b in FIG. 8. At 1206a, the SMF 1242 may send a request message to the NF 1244 for session setup, such that the request message may include any of the following information: WTRU ID; fine-grained security profile; service information and/or ciphertext. At 1206b, in response to receiving the request message from SMF 1242, NF 1244 may verify the service-level token to make sure WTRU 1232 have the authority to access the service. At 1206c, NF 1244 may decapsulate the ciphertext to get MSSK. At 1206d, NF 1244 may send a response message to SMF 1242 including indication of the success of key derivation and indication of a corresponding key lifetime. Step 1207 may be the same as step 808 of FIG. 8. Step 1208 may be the same as step 809 of FIG. 8. At 1209, the WTRU 1232 and NFs may follow steps to finish the PDU session establishment (refer to 23.501), and the WTRU 1232 may send to the NF 1244 a message including a notification of success of key derivation.

Steps 1210-1218 illustrate example embodiment 2, such that MSSK is distributed via UP, and service data is transmitted over UP. At 1210, a PDU session is established between WTRU 1232 and NF 1244. At 1211, WTRU 1232 may send a secure service connection request message to the NF 1244 over UP (e.g., the established PDU session). The secure service connection request message may include any of the following information: WTRU ID; NF information (e.g., NF name, NF address); service information (e.g., service name, service ID, service-level token); ciphertext; and/or security requirement for the requested service (e.g., whether confidentiality and/or integrity protection is preferred or optional or not needed; and the required security level if protection is required, PQC-based key distribution). At 1212, NF 1244 may verify the service-level token to make sure WTRU 1232 have the authority to access the service. Steps 1213-1215 are the same as step 904-906 of FIG. 9. At 1216, NF 1244 may decapsulate the ciphertext to get MSSK. Steps 1217-1218 are the same as step 908-909 of FIG. 9.

Steps 1219-1221 illustrate example embodiment 3, such that MSSK is distributed via CP, and service data is transmitted over CP. At 1219, WTRU 1232 sends a secure service connection request message to the NF 1244 over CP (e.g., via Nran, or via N1 to access SBI). The secure service connection request message may include any of the following information: WTRU ID; NF information (e.g., NF name, NF address); service information (e.g., service name, service ID, service-level token); ciphertext, and/or security requirement for the requested service (e.g., whether confidentiality and/or integrity protection is preferred or optional or not needed; and the required security level if protection is required, PQC-based key distribution). At 1220a, NF 1244 may the service-level token to make sure WTRU 1232 have the authority to access the service. At 1220b, NF 1244 may decapsulate the ciphertext to get MSSK. At 1221, NF 1244 may send a secure service connection response message to the WTRU 1232 over CP indicating the successful service key derivation at NF and corresponding key lifetime.

At 1222a and 1222b, WTRU 1232 and NF 1244, respectively, may derive K_{SDF}/K_{QFI} using MSSK (for example embodiments 1 and 2) or WTRU 1232 and NF 1244, respectively, may derive K_{Service} using MSSK (for example embodiment 3). At 1223, WTRU 1232 and NF 1244 may communicate securely with PQC end-to-end over the CP or UP connection.

Example procedures for WTRU-requested PQC-based WTRU-NF fine-grained secure communication between establishment without an SF are disclosed herein. FIG. 13 is a flow diagram illustrating an example fine-grained secure E2E communication procedure 1300 with the NF 1332, and based on PQC protection. The example system may include: WTRU 1322; RAN 1324 (e.g., base station); AMF/SEAF 1326; eNRF 1328; SMF 1330; NF 1332; and PCF 1334. A difference between procedure 1200 in FIG. 12 and procedure 1300 in FIG. 13 is that in FIG. 12, SF is used to store the NF PQC algorithm names and public keys, while in FIG. 13, SF is not used and each entity (e.g., WTRU or NF) stores the PQC information on its own.

With reference to procedure 1300 in FIG. 13, steps 1301-1309 illustrate an example embodiment 1: MSSK is distributed via UP, service data is transmitted over UP. At 1301, a PDU session may be established between WTRU 1322 and NF 1332. At 1302, WTRU 1322 may send a secure service connection request message to the WTRU 1322 over UP (e.g., the established PDU session). The secure service connection request message may include any of the following information: WTRU ID; NF information (e.g., NF name, NF address); service information (e.g., service name, service ID, service-level token), WTRU PQC encapsulation key (PQC.KEM.ek_WTRU); and security requirement for the requested service (e.g., whether confidentiality and/or integrity protection is preferred or optional or not needed; PQC-based key distribution is required and the preferred security level). Steps 1303-1306 are the same as step 1212-1215 of FIG. 12. At 1307, NF 1332 may encapsulate MSSK with the received WTRU PQC encapsulation key (PQC.KEM.ek_WTRU) to a ciphertext. Step 1308 may be the same as step 1217 of FIG. 12. At 1309, NF 1332 may send a secure service connection response message to the WTRU 1322 over UP with the Ciphertext.

Steps 1310-1312 illustrate an example embodiment 2, such that MSSK is distributed via CP, and service data is transmitted over CP. At 1310, WTRU 1322 may send a secure service connection request message to the WTRU 1322 over CP (e.g., via Nran, or N1 to access SBI). The secure service connection request message may include any of the following information: WTRU ID NF information (e.g., NF name, NF address); service information (e.g., service name, service ID, service-level token); WTRU PQC encapsulation key (PQC.KEM.ek_WTRU); and/or security requirement for the requested service (e.g., whether confidentiality and/or integrity protection is preferred or optional or not needed; PQC-based key distribution is required and the preferred security level). At 1311a, NF 1332 may verify the service-level token to make sure WTRU 1322 has the authority to access the service. At 1311b, NF 1332 may encapsulate MSSK with the received WTRU PQC encapsulation key (PQC.KEM.ek_WTRU) to a ciphertext. At 1312, NF 1332 may send a secure service connection response message to the WTRU 1322 over CP with ciphertext.

At 1313, WTRU 1322 may decapsulate ciphertext to get MSSK. At 1314, WTRU 1322 may send a notification message to NF 1332 indicating the success of decapsulation of ciphertext. At 1315a and 1315b, WTRU 1322 and NF 1332, respectively, may derive K_{SDF}/K_{QFI} using MSSK (for example embodiment 1); or WTRU 1322 and NF 1332, respectively, may derive K_{Service} using MSSK (for embodiment 2). At 1316, WTRU 1322 and NF 1332 may communicate securely end-to-end over the CP or UP connection.

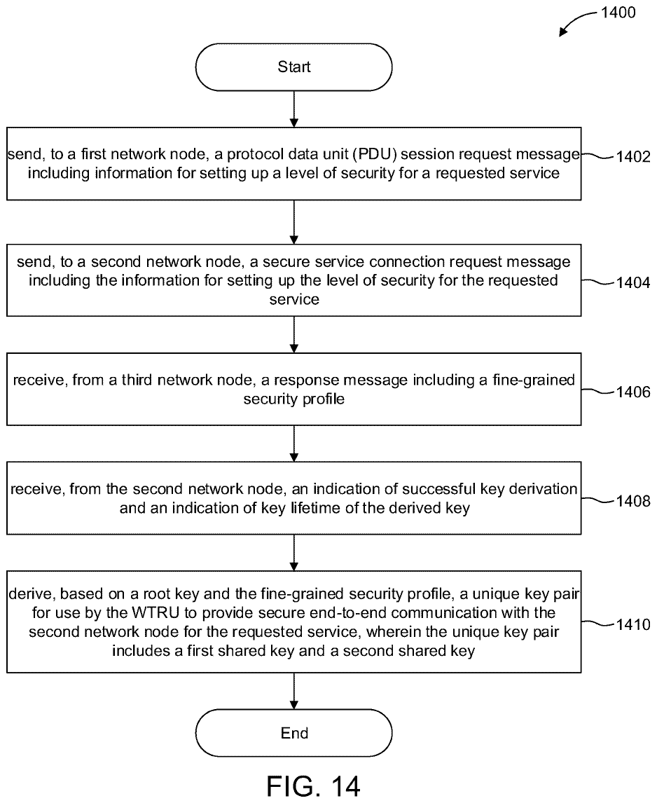

FIG. 14 is a flow diagram illustrating an example fine-grained secure end-to-end connection establishment procedure 1400 between a WTRU and an NF using a key distribution approach. At 1402, the WTRU may send, to a first network node, a protocol data unit (PDU) session request message including information for setting up a level of security for a requested service. At 1404, the WTRU may send, to a second network node, a secure service connection request message including the information for setting up the level of security for the requested service. At 1406, the WTRU receive, from a third network node, a response message including a fine-grained security profile. At 1408, the WTRU may receive, from the second network node, an indication of successful key derivation and an indication of key lifetime of the derived key. At 1410, the WTRU may derive, based on a root key and the fine-grained security profile, a unique key pair for use by the WTRU to provide secure end-to-end communication with the second network node for the requested service, wherein the unique key pair includes a first shared key and a second shared key.

The information for setting up the level of security for the requested service nay include one or more of the following information: WTRU identifier (ID); NF information; NF name; NF identifier (ID); NF address; NF instance ID; service information of the requested service; service name of the requested service; Service ID of the requested service; service level token of the requested service; security function (SF) information; SF name; SF address; SF ID; root key ID; fine-grained security requirements; indication to enable post-quantum cryptography (PQC)-based protection; WTRU PQC encapsulation key; or PQC ciphertext. The secure service connection request message may be sent via one of the following: an established PDU session in a user plane (UP); an N1 interface for control plane (CP)-terminated communication with a network function (NF); or CP interface accessing a service based interface (SBI) gateway for CP-terminated communication with the NF. The fine-grained security profile may include one or more of the following information: a service data flow (SDF) filter to map service data associated with the requested service to one or more SDFs; SDF identifier (ID); security rules for the one or more SDFs including whether to apply confidentiality and whether to apply integrity protection for these SDFs, and indicator of SDF level security or QoS Flow level security; or QoS Flow ID (QFI).

The WTRU may derive the unique key pair by running a key derivation function to derive the first shared key using the root key and parameters included in the information for setting up the level of security to guarantee a uniqueness of the first shared key, wherein the first shared key is an NF key. The WTRU may derive the second shared key for each service, SDF, or QoS flow using either the first shared key or the root key to guarantee the uniqueness and key separation, wherein the second shared key is a fine-grained security key. The WTRU may send, to the second network node, an indication of successful key derivation. The level of security may be one of: a service data flow (SDF) level, a quality of service (QoS) flow level, or a service level. The first network node may include an access and mobility management function (AMF), the second network node may include a network function (NF), and the third network node may include a session management function (SMF). The information for requesting the PQC public key includes of the NF includes one or more of: WTRU identifier (ID); NF ID; PQC algorithm name; or security function (SF) token.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a transceiver; and
a processor, wherein the transceiver and the processor are configured to:
send, to a first network node, a protocol data unit (PDU) session request message including information for setting up a level of security for a requested service;
send, to a second network node, a secure service connection request message including the information for setting up the level of security for the requested service;
receive, from a third network node, a response message including a fine-grained security profile;
receive, from the second network node, an indication of successful key derivation and an indication of key lifetime of the derived key; and
derive, based on a root key and the fine-grained security profile, a unique key pair for use by the WTRU to provide secure end-to-end communication with the second network node for the requested service, wherein the unique key pair includes a first shared key and a second shared key.

2. The WTRU of claim 1, wherein the information for setting up the level of security for the requested service includes one or more of: WTRU identifier (ID); NF information; NF name; NF identifier (ID); NF address; NF instance ID; service information of the requested service; service name of the requested service; Service ID of the requested service; service level token of the requested service; security function (SF) information; SF name; SF address; SF ID; root key ID; fine-grained security requirements; indication to enable post-quantum cryptography (PQC)-based protection; WTRU PQC encapsulation key; or PQC ciphertext.

3. The WTRU of claim 1, wherein the secure service connection request message is sent via one of the following: an established PDU session in a user plane (UP); an N1 interface for control plane (CP)-terminated communication with a network function (NF); or CP interface accessing a service based interface (SBI) gateway for CP-terminated communication with the NF.

4. The WTRU of claim 1, wherein the fine-grained security profile includes one or more of: a service data flow (SDF) filter to map service data associated with the requested service to one or more SDFs; SDF identifier (ID); security rules for the one or more SDFs including whether to apply confidentiality and whether to apply integrity protection for the one or more SDFs; and indicator of SDF level security or QoS Flow level security; or QoS Flow ID (QFI).

5. The WTRU of claim 1, wherein the transceiver and the processor are configured to derive the unique key pair by:
running a key derivation function to derive the first shared key using the root key and parameters included in the information for setting up the level of security to guarantee a uniqueness of the first shared key, wherein the first shared key is an NF key; and
deriving the second shared key for each service, SDF, or QoS flow using either the first shared key or the root key to guarantee the uniqueness and key separation, wherein the second shared key is a fine-grained security key.

6. The WTRU of claim 1, wherein the transceiver and the processor are further configured to:
send, to the second network node, an indication of successful key derivation.

7. The WTRU of claim 1, wherein the level of security is one of: a service data flow (SDF) level, a quality of service (QoS) flow level, or a service level.

8. The WTRU of claim 1, wherein the first network node includes an access and mobility management function (AMF), the second network node includes a network function (NF), and the third network node includes a session management function (SMF).

9. The WTRU of claim 1, wherein the transceiver and the processor are further configured to:
send, to a fourth network node including a security function (SF), a key request message including information for requesting a post-quantum cryptography (PQC) public key of a network function (NF) residing on the second network node.

10. The WTRU of claim 9, wherein the information for requesting the PQC public key includes of the NF includes one or more of: WTRU identifier (ID); NF ID; PQC algorithm name; or security function (SF) token.

11. A method performed by a wireless transmit/receive unit (WTRU), the method comprising:
sending, to a first network node, a protocol data unit (PDU) session request message including information for setting up a level of security for a requested service;
sending, to a second network node, a secure service connection request message including the information for setting up the level of security for the requested service;
receiving, from a third network node, a response message including a fine-grained security profile;
receiving, from the second network node, an indication of successful key derivation and an indication of key lifetime of the derived key; and
deriving, based on a root key and the fine-grained security profile, a unique key pair for use by the WTRU to provide secure end-to-end communication with the second network node for the requested service, wherein the unique key pair includes a first shared key and a second shared key.

12. The method of claim 11, wherein the information for setting up the level of security for the requested service includes one or more of: WTRU identifier (ID); NF information; NF name; NF identifier (ID); NF address; NF instance ID; service information of the requested service; service name of the requested service; Service ID of the requested service; service level token of the requested service; security function (SF) information; SF name; SF address; SF ID; root key ID; fine-grained security requirements; indication to enable post-quantum cryptography (PQC)-based protection; WTRU PQC encapsulation key; or PQC ciphertext.

13. The method of claim 11, wherein the secure service connection request message is sent via one of the following: an established PDU session in a user plane (UP); an N1 interface for control plane (CP)-terminated communication with a network function (NF); or CP interface accessing a service based interface (SBI) gateway for CP-terminated communication with the NF.

14. The method of claim 11, wherein the fine-grained security profile includes one or more of: a service data flow (SDF) filter to map service data associated with the requested service to one or more SDFs; SDF identifier (ID); security rules for the one or more SDFs including whether to apply confidentiality and whether to apply integrity protection for the one or more SDFs; indicator of SDF level security or QoS Flow level security; or QoS Flow ID (QFI).

15. The method of claim 11, wherein the deriving the unique key pair includes:
running a key derivation function to derive the first shared key using the root key and parameters included in the information for setting up the level of security to guarantee a uniqueness of the first shared key, wherein the first shared key is an NF key; and
deriving the second shared key for each service, SDF, or QoS flow using either the first shared key or the root key to guarantee the uniqueness and key separation, wherein the second shared key is a fine-grained security key.

16. The method of claim 11, further comprising:
sending, to the second network node, an indication of successful key derivation.

17. The method of claim 11, wherein the level of security is one of: a service data flow (SDF) level, a quality of service (QoS) flow level, or a service level.

18. The method of claim 11, wherein the first network node includes an access and mobility management function (AMF), the second network node includes a network function (NF), and the third network node includes a session management function (SMF).

19. The method of claim 11, further comprising:
sending, to a fourth network node including a security function (SF), a key request message including information for requesting a post-quantum cryptography (PQC) public key of a network function (NF) residing on the second network node.

20. The method of claim 19, wherein the information for requesting the PQC public key includes of the NF includes one or more of: WTRU identifier (ID); NF ID; PQC algorithm name; or security function (SF) token.
